(19) United States
(12) Patent Application Publication
(10) Pub. No.: US 2026/0124734 A1
(43) Pub. Date: May 7, 2026

(54) Clip-Accessory Mounting System

(71) Applicant: Robert Bosch GmbH, Stuttgart (DE)

(72) Inventors: Jaime Moreno Terrazas, Imperial, CA (US); Jeremy Rubens, Palatine, IL (US)

(21) Appl. No.: 19/373,080

(22) Filed: Oct. 29, 2025

Related U.S. Application Data
(60) Provisional application No. 63/715,259, filed on Nov. 1, 2024.

(51) Int. Cl. B25F 5/02; B24B 23/00

(52) U.S. Cl. CPC B25F 5/02; B24B 23/005

(57) ABSTRACT

In one embodiment, a power tool system includes a hand power tool and a baseplate assembly configured to be mounted on the hand power tool. The baseplate assembly includes a locking member configured to rotate about a first axis. The locking member is configured to rotate about the first axis between a first position whereat an accessory clip cannot be locked to the baseplate assembly, and a second position whereat the accessory clip can be locked to the baseplate assembly. The locking member is configured to flex a portion of the accessory clip away from the first axis as the locking member rotates from the first position to the second position during a mounting process thereby locking the accessory clip to the baseplate assembly.

This application claims priority to U.S. Application No. 63/715,259, filed on Nov. 1, 2024, the disclosure of which is incorporated herein by reference in its entirety.

The disclosure relates to hand power tools and more specifically to hand power tool systems with multiple accessory tools.

### BACKGROUND

Hand power sander tools come in various models to suit different applications. Such models include random orbit motion models and orbit motion models. Traditional sanders often use sanding plates attached to the main drive plate via screws, which is connected to the motor eccentric and flexible mounting arms. The sanding plates are used to modify the surface of a workpiece. Some hand power tools are configured to be used with different types of accessory tools in addition to sander tools. Changing between accessory tools requires detachment of one accessory tool and replacement with another accessory tool. In many systems, this process is cumbersome and can result in an unstable securement of the accessory tool.

What is needed is a system which allows users to quickly and easily switch between different accessories. A system which ensures that accessories remain firmly attached during use, providing a reliable and safe operation would be beneficial. A system which allows various accessories to be quickly and effortlessly exchanged would be helpful. A system which enables stable and precise sanding would also be beneficial.

### SUMMARY

In one embodiment, a power tool system includes a hand power tool and a baseplate assembly configured to be mounted on the hand power tool. The baseplate assembly includes a locking member configured to rotate about a first axis. The locking member is configured to rotate about the first axis between a first position whereat an accessory clip cannot be locked to the baseplate assembly, and a second position whereat the accessory clip can be locked to the baseplate assembly. The locking member is configured to flex a portion of the accessory clip away from the first axis as the locking member rotates from the first position to the second position during a mounting process thereby locking the accessory clip to the baseplate assembly.

In one or more embodiments, the power tool system further includes a baseplate of the baseplate assembly. In at least some of these embodiments, the baseplate assembly is configured to be mounted to the hand power tool by attachment of the baseplate to the hand power tool. The baseplate in some embodiments includes a locking port. The locking member includes a locking plate and a locking arm extending upwardly from the locking plate and configured to extend into the locking port. The locking port is configured to receive a locking tab, of the accessory clip, outwardly of the locking arm when the locking arm is extended into the locking port. The locking tab is the portion of the accessory clip which the locking member is configured to flex, and the locking member is configured to flex the locking tab with the locking arm.

In one or more embodiments of the power tool system the locking port is configured to receive the locking tab, including an outwardly extending locking lip of the locking tab, without flexing of the locking tab. In these embodiments the locking port is configured such that as the locking arm flexes the locking tab, the outwardly extending locking lip extends over a portion of the baseplate.

In one or more embodiments of the power tool system the locking arm includes an outwardly extending latching member configured to contact a sloped portion of the locking tab as the locking arm flexes the locking tab. The latching member is configured to be positioned at least partially within an inwardly facing groove of the locking tab when the locking member is in the second position with the locking tab positioned outwardly of the locking arm.

In one or more embodiments of the power tool system the locking plate includes a circular center portion configured to mate with a circular center portion of the accessory clip. In at least some of these embodiments the locking plate includes an expanded end portion configured to mate with an expanded end portion of the accessory clip such that when the locking tab is positioned in the locking port outwardly of the locking arm, the circular center portions of the locking plate and the accessory clip are mated and the expanded end portions of the locking plate and the accessory clip are mated thereby firmly orienting the accessory clip with the baseplate assembly.

In one or more embodiments of the power tool system the baseplate includes a first plurality of dust ports, the locking plate includes a second plurality of dust ports, and the first plurality of dust ports and the second plurality of dust ports are configured such that when the accessory clip is locked to the baseplate assembly, the first plurality of dust ports and the second plurality of dust ports are aligned with a third plurality of dust ports of the accessory clip.

In one or more embodiments of the power tool system the power tool system includes one or more accessory clips.

In one or more embodiments of the power tool system the accessory clip is configured to couple with at least one tool selected from a group of tools consisting of a curved detail sponge tool, a straight scraper tool, a sand paper sander tool, a detailer tool, a sanding block tool, a scuff pad tool, a pull scraper tool, and a wire brush tool.

In one or more embodiments of the power tool system the accessory clip is configured to couple with the selected tool using Velcro. In some embodiments, the accessory clip is configured to couple with the selected tool using an interference fit

In one or more embodiments of the power tool system the power tool system includes a scraper tool and the accessory clip is configured to couple with the scraper tool. In one or more of these embodiments, the accessory clip includes a first mounting area including an anchor portion, a plurality of ribs, and a base support flange. The scraper tool includes a base portion configured to be positioned on the base portion of the accessory clip in the first mounting area, two support wings extending upwardly from the base portion and configured to be positioned against the plurality of ribs, a mounting hole extending through the base portion and configured to align with the anchor portion, a scraper blade extending downwardly from one end of the base portion, and a support flange extending downwardly from an opposite end of the base portion and configured to abut a portion of the base support flange in the first mounting area.

In one or more embodiments of the power tool system the accessory clip includes a second mounting area including a further anchor portion, a further plurality of ribs, and the base support flange. In at least some of these embodiments the scraper tool base portion is configured to be positioned on the base portion of the accessory clip in the second mounting area, the two support wings are configured to be positioned against the further plurality of ribs, the mounting hole is configured to align with the further anchor portion, and the support flange is configured to abut a portion of the base support flange in the second mounting area.

In one or more embodiments of the power tool system the baseplate of the baseplate assembly includes a support member pivotably mounted to the baseplate assembly by a pivot defining a pivot axis parallel to the first axis.

In one or more embodiments of the power tool system the baseplate includes a pivot and a mating channel. The pivot is configured to couple with a pivot member of a further accessory clip, and the mating channel is configured to provide a keyed engagement with the further accessory clip.

In one or more embodiments of the power tool system the baseplate is further configured to form a latching configuration with the further accessory clip.

### BRIEF DESCRIPTION OF THE DRAWINGS

FIG. 1 shows a side perspective view of a sander system which includes a sander, a baseplate assembly, and an accessory clip.

FIG. 2 is a partial perspective view of the anchor subsystem of FIG. 1 showing posts which define threaded receptacles.

FIG. 3 is a bottom perspective view of the baseplate assembly of FIG. 1 showing screws for connecting the baseplate assembly to the posts 118.

FIG. 4 shows the bottom perspective view of FIG. 3 with lock plate removed.

FIG. 5 is a bottom perspective view of the lock actuators of FIG. 3 in a released position.

FIG. 6 shows a top perspective view of the accessory clip of FIG. 1.

FIG. 7 shows a bottom perspective view of the accessory clip of FIG. 1 with Velcro attached thereto.

FIG. 8 shows various accessory tools which in some embodiments are additionally or alternatively provided in a clip-accessory mounting kit.

FIG. 9 shows a side perspective view of a further embodiment of an accessory clip which in some clip-accessory mounting kits is additionally and/or alternatively provided.

FIG. 10 is a partial side perspective view of the accessory clip of FIG. 9 attached to a sander with an accessory tool 182 interference fit into a cavity of the accessory clip.

FIG. 11 shows another accessory clip which is additionally or alternatively provided in the clip-accessory mounting kit.

FIG. 12 shows the accessory clip of FIG. 11 attached to the baseplate assembly of the sander with a scraper attached to provide a front scraper configuration.

FIG. 13 shows the accessory clip of FIG. 11 attached to the baseplate assembly of the sander with a scraper attached to provide a rear scraper configuration.

FIG. 14 is a top perspective view of another accessory clip which is additionally or alternatively provided in the clip-accessory mounting kit for use with an accessory tool in the form of sandpaper.

FIG. 15 is a side perspective view of the accessory clip of FIG. 14 mounted to a sander.

FIG. 16 shows the accessory clip of FIG. 1 aligned with the baseplate assembly of FIG. 1 in preparation for mounting the accessory clip to the baseplate assembly.

FIG. 17 shows a top perspective view of the accessory clip of FIG. 1 with a locking arms inserted into the two locking ports of the baseplate assembly during a mounting process.

FIG. 18 shows the accessory clip of FIG. 1 firmly attached to the baseplate assembly of FIG. 1 with the locking arm locked with the locking tab.

FIG. 19 shows a top perspective view of a baseplate assembly which in some embodiments is additionally or alternatively provided in the clip-accessory mounting kit.

FIG. 20 shows a bottom perspective view of a baseplate assembly which in some embodiments is additionally or alternatively provided in the clip-accessory mounting kit.

FIG. 21 shows a bottom perspective view of baseplate assembly which in some embodiments is additionally or alternatively provided in the clip-accessory mounting kit.

FIG. 22 shows a top perspective view of the baseplate assembly of FIG. 21 attached a hand sander.

FIG. 23 shows a bottom perspective view of a baseplate assembly which in some embodiments is additionally or alternatively provided in the clip-accessory mounting kit.

FIG. 24 shows a bottom perspective view of the baseplate assembly of FIG. 23 with an additional support pivoted to provided additional supper for an accessory tool.

FIG. 25 shows a side perspective view of an alternative baseplate assembly and an alternative accessory clip.

FIG. 26 shows a top perspective view of the accessory clip of FIG. 25.

FIG. 27 shows a bottom perspective view of the baseplate of FIG. 25.

FIG. 28 shows a bottom perspective view of a sander to which the baseplate assembly of FIG. 25 can be mounted.

FIG. 29 shows a top perspective view of the baseplate assembly and the accessory clip of FIG. 25 during a mounting process.

FIG. 30 shows a top perspective view of the baseplate assembly with the accessory clip mounted to the baseplate assembly.

FIG. 31 shows a top perspective view of an accessory clip which extends only partly across the bottom of an associated baseplate assembly.

### DETAILED DESCRIPTION

For the purpose of promoting an understanding of the principles of the disclosure, reference will now be made to the embodiments illustrated in the drawings and described in the following written description. It is to be understood that no limitation to the scope of the disclosure is thereby intended. It is further to be understood that the present disclosure includes any alterations and modifications to the illustrated embodiments and includes further applications of the principles of the disclosure as would normally occur to one skilled in the art to which this disclosure pertains.

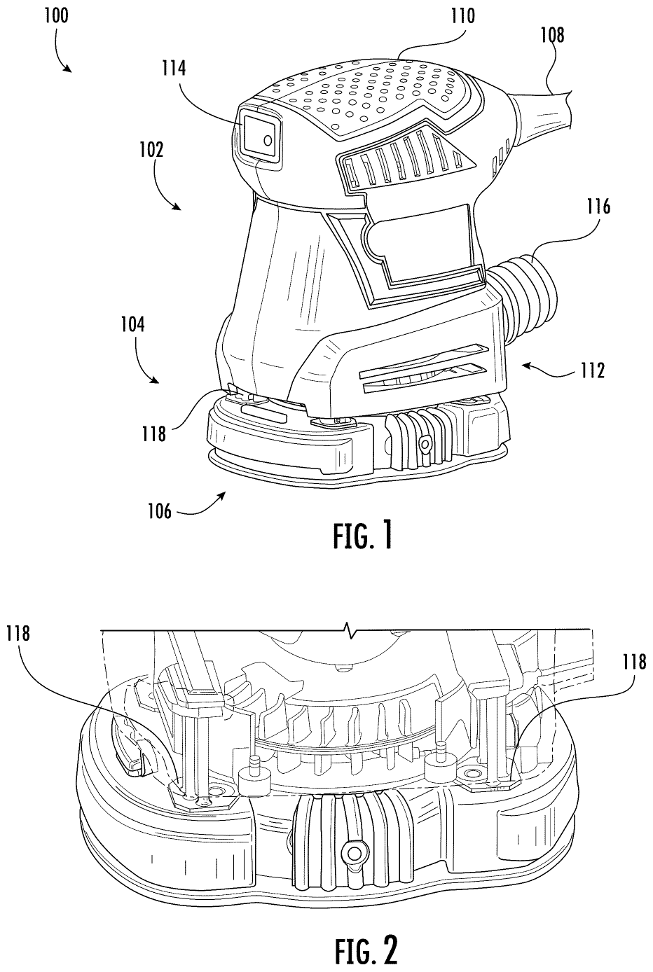

FIG. 1 shows a sander system 100 which includes a sander 102, a baseplate assembly 104, and an accessory clip 106. The sander 102 in this embodiment is powered through a cord 108 but in other embodiments is battery operated. The sander 102 includes a grip portion 110 and an anchor subsystem 112. A switch 114 is provided to control power to the sander 102. A vacuum connection 116 is provided for connection with a vacuum system.

The anchor subsystem 112 in this embodiment includes a number of anchor components in the form of posts 118, also shown in FIG. 2, which define threaded receptacles. In other embodiments, more or fewer anchor components are provided. The anchor component or components are configured to provide a stable connection with the baseplate assembly 104 which is easily accessible.

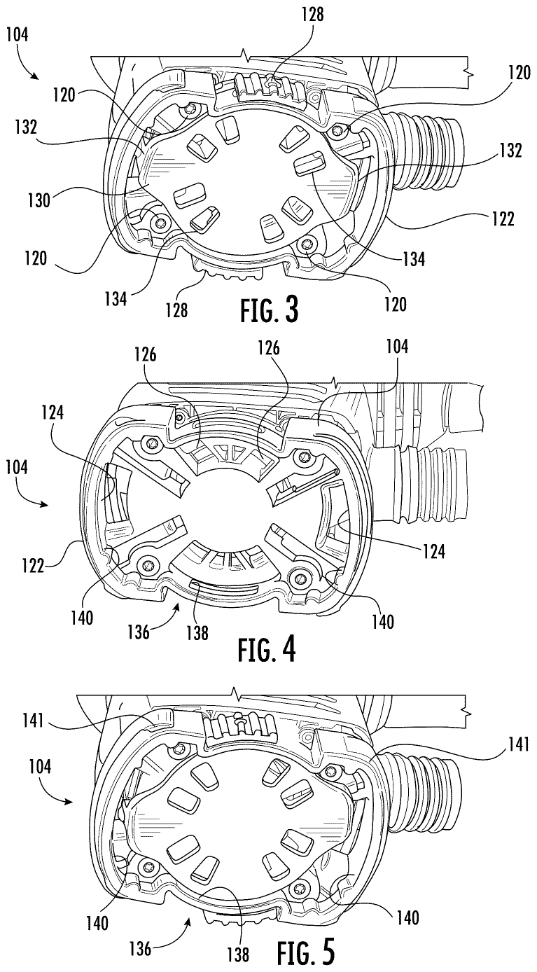

As shown in FIG. 3, screws 120 are provided for connecting the baseplate assembly 104 to the posts 118. The screws 120 extend through a baseplate 122 which includes two locking ports 124 and a number of dust ports 126 shown in FIG. 4. Returning to FIG. 3, the baseplate assembly 104 includes two lock actuators 128 which are operably connected to a lock plate 130. Two locking arms 132 extend from the lock plate 130, each of which extend through a respective one of the two locking ports 124. The lock plate 130 further includes a number of dust ports 134 and a mating cavity 136 which includes a circular center portion 138 and two expanded end portions 140. The two lock actuators 128 are actuated by a user to move the lock plate 130 between a locked position shown in FIG. 3 and a released position shown in FIG. 5 as discussed further below. At least in the locked position of FIG. 3 at least some of the number of dust ports 134 are aligned with respective ones of the number of dust ports 126. Two dust channels 141 are provided at end portions of the baseplate 122 (see FIG. 5) which allow for dust collection when airflow through the number of dust ports 126 is blocked by an accessory.

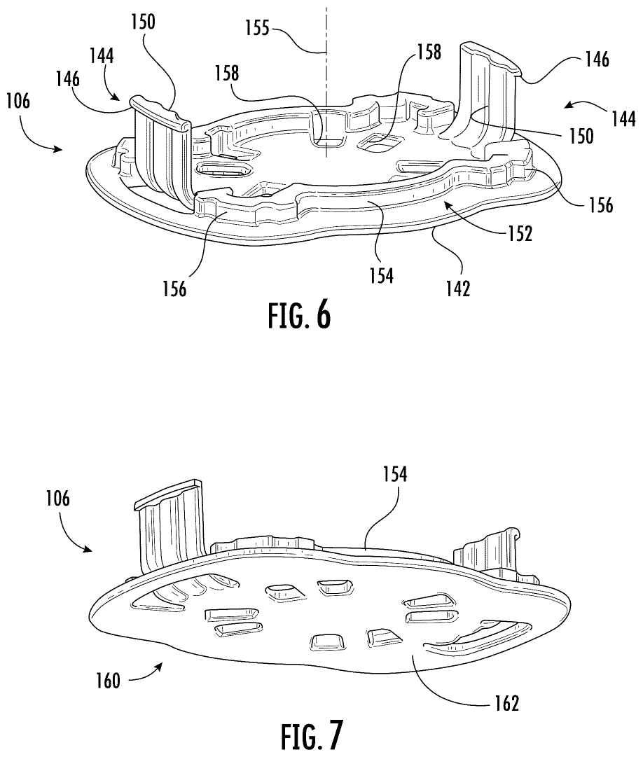

FIG. 6 shows a top perspective view of the accessory clip 106. The accessory clip 106 includes a base portion 142 from which two locking tabs 144 extend. Each locking tab includes an outwardly extending locking lip 146 and an inwardly facing latch groove 150. The base portion 142 includes an upwardly extending mating protrusion 152 which includes a circular center portion 154 which defines an axis 155 and two expanded end portions 156. A number of dust ports 158 extend through the base portion 142. A lower surface 160 of the accessory clip 106, shown in FIG. 7, has Velcro 162 attached thereto.

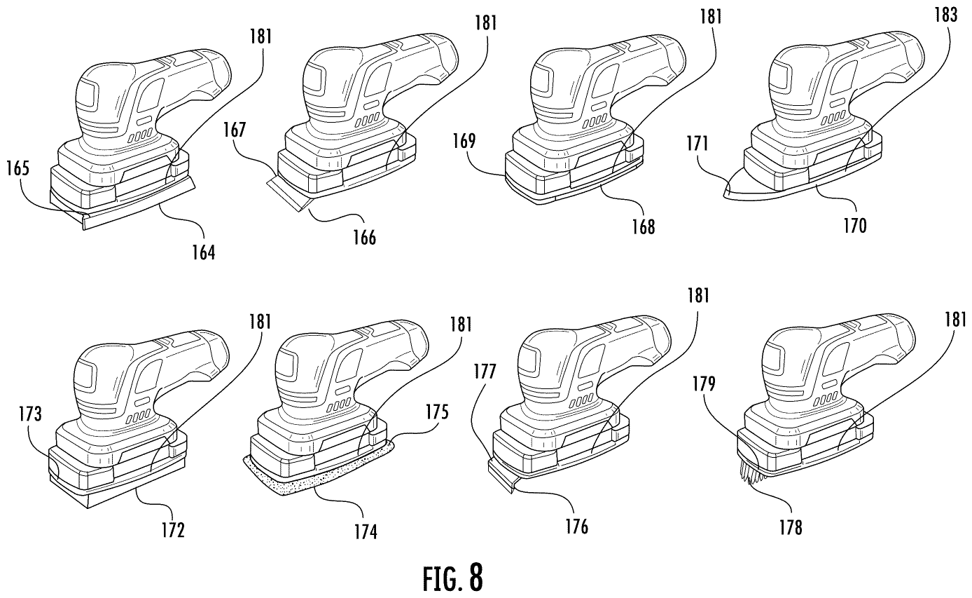

The Velcro 162 is used to couple an accessory tool with the accessory clip 106. Some accessory tools, some or all of which are included in a clip-accessory mounting kit, which may include the sander 102 and/or baseplate assembly 104, are shown in FIG. 8. Accessory tools shown in FIG. 8 which are provided with a complementary Velcro attachment member for removable attachment to the Velcro 162 include a curved detail sponge 164 with Velcro attachment member 165, a straight scraper 166 with Velcro attachment member 167, standard sand paper 168 with Velcro attachment member 169, a detailer 170 with Velcro attachment member 171, a sanding block 172 with Velcro attachment member 173, a scuff pad 174 with Velcro attachment member 175, a pull scraper 176 with Velcro attachment member 177, and a wire brush 178 with Velcro attachment member 179.

FIG. 8 further shows accessory clips 181 and 183, either or both of which in some embodiments are additionally or alternatively provided in the clip-accessory mounting kit. The base portion of the accessory clip 181 is shaped differently than the base portion 142 of the accessory clip 106, but is otherwise identical to the accessory clip 106. This allows for the accessory clip to be optimized to a particular accessory tool if desired. For example, the accessory clips 183 has a forward extension which provides additional support for the detailer 170.

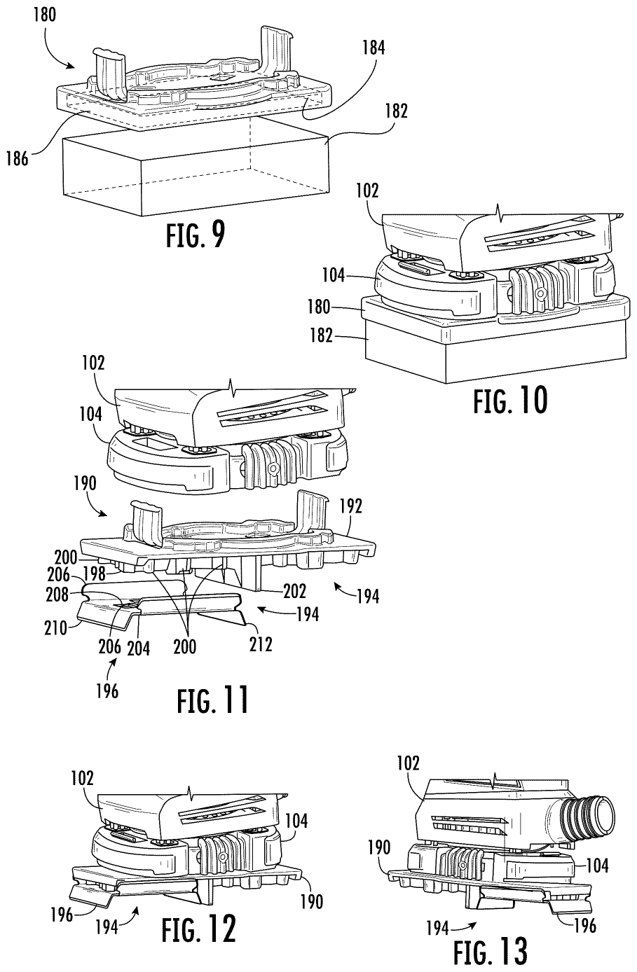

A further embodiment of an accessory clip is depicted in FIG. 9, which in some clip-accessory mounting kits is additionally and/or alternatively provided. The accessory clip 180 is substantially identical to the accessory clip 106. The difference is that rather than Velcro, an accessory tool 182, which in some embodiments is included in the clip-accessory mounting kit, s is attached to the accessory clip 180 using an interference grip. This is accomplished by providing a cavity 184 in the base portion 186. The cavity 184 is shaped and sized so as to provide the interference fit when the accessory tool 182 is inserted into the cavity 184 as shown in FIG. 10.

Another accessory clip which is additionally or alternatively provided in the clip-accessory mounting kit is the accessory clip 190 shown in FIG. 11. The accessory clip 190 is substantially identical to the accessory clip 106. The difference is that rather than Velcro the accessory clip 190 includes base portion 192 which is configured to provide at least one mounting area 194 for a scraper 196. In the embodiment of FIG. 11, two mirrored mounting areas 194 are provided. The at least one mounting area 194 in FIG. 11 includes an anchor portion 198, a plurality of ribs 200, and a base support flange 202. The scraper 196 includes a base portion 204. Two support wings 206 extend upwardly from the base portion 204 and a mounting hole 208 extends through the base portion 204. A scraper blade 210 extends downwardly from one end of the base portion 204 and a support flange 212 extends downwardly from an opposite end of the base portion 204.

To mount the scraper 196 to the accessory clip 190, the mounting hole 208 is aligned with the anchor portion 198 of the forward at least one mounting area 194. The base portion 204 is then positioned against the base portion 192 with the two support wings 206 abutting the plurality of ribs 200 and the support flange 212 abutting the base support flange 202. A fastening component (not shown) such as a screw is then inserted into the anchor portion 198 through the mounting hole 208 to tightly connect the scraper 196 to the accessory clip 190. The resulting configuration is shown in FIG. 12. In similar fashion, the scraper 196 can be mounted on the rearward at least one mounting area 194 to provide a rear scraper as shown in FIG. 13. Alternatively, the scraper 196 is mounted using an interference fit or a snap-on fit.

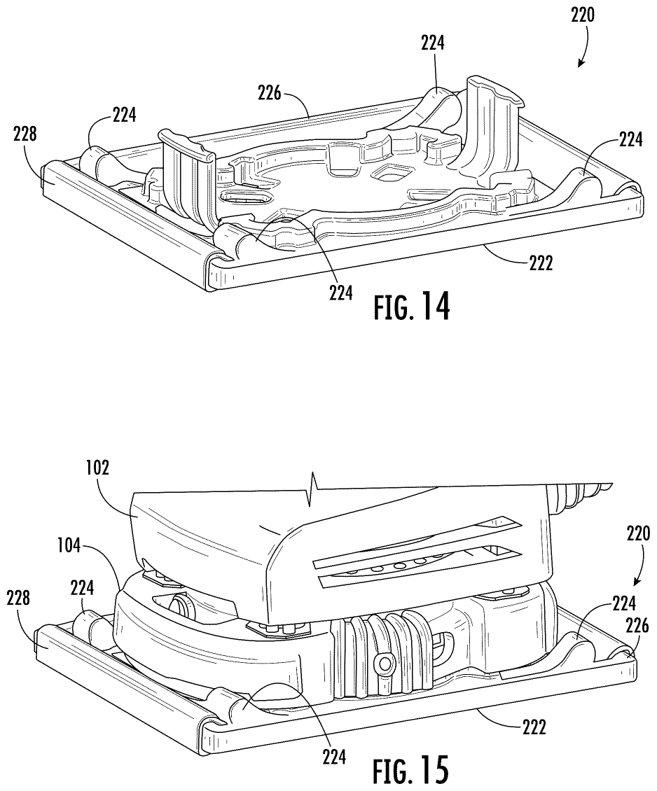

Another accessory clip which is additionally or alternatively provided in the clip-accessory mounting kit is the accessory clip 220 shown in FIG. 14. The accessory clip 220 is substantially identical to the accessory clip 106. The difference is that rather than Velcro the accessory clip 220 includes base portion 222 which includes a number of clips 224 and an upwardly extending lip 226. While four clips 224 are shown in FIG. 14, in other embodiments a single clip 224 is provided on each end of the base portion 222. The clips open outwardly and are resilient. The lip 226 extends completely around the upper surface of the base portion 222. In other embodiments, one lip 226 is provided at one end of the base portion 222 and a second lip 226 is provided at the opposite end.

The accessory clip 220 is used with an accessory tool in the form of a piece of sand paper 228 which in some embodiments is included in the clip-accessory mounting kit. The sand paper 228 is mounted to the accessory clip 220 by sliding one edge of the sand paper 228 over the lip 226 at one end of the base portion 222. The sand paper 228 is then forced beneath the two clips 224 at the associated end of the base portion 222 resiliently forcing the clips 224 away from the base portion 222. The sand paper 228 is thus clamped between the two clips 224 and the base portion 222. The lip 226 provides increased resistance to slipping of the sand paper 228 out of the two clips 224. The same process is performed at the opposite end of the base portion 222 to securely clamp the sand paper 228 to the accessory clip 220 resulting in the configuration of FIG. 15 when the accessory clip 220 and lip 226 are mounted to the baseplate assembly 104.

Any or all of the accessory tools discussed above can be mounted to the associated accessory clip in the manner described above either before or after mounting the associated accessory clip to the baseplate assembly 104. Mounting of the baseplate assembly 104 to the anchor subsystem 112 is typically accomplished prior to mounting the accessory clip to the baseplate assembly 104 so as to ensure easy access to the anchor subsystem 112. Mounting of the baseplate assembly 104 to the anchor subsystem 112 is accomplished by aligning the baseplate 122 with the anchor subsystem 112 so that the screws 120 can be inserted through mounting holes in the baseplate 122 and into the threaded bores in the posts 118. The screws 120 are then used to firmly mount the baseplate assembly 104 to the anchor subsystem 112 resulting in the configuration shown in FIG. 4.

With the baseplate assembly 104 firmly mounted to the anchor subsystem 112 as described above and shown in FIG. 4, in which the lock plate 130 is not shown for purpose of clarity, any of the above-described accessory clips is easily mounted to the baseplate assembly 104 in the same manner which is described with reference to the accessory clip 106 and FIG. 16. Initially, the two lock actuators 128 are positioned in the release position and the two locking tabs 144 are aligned with the two locking ports 124 as shown in FIG. 16 (see two locking ports 124 in FIG. 3). Positioning the two lock actuators 128 in the release position moves the two locking arms 132 to the side of the two locking ports 124 as shown in FIG. 5. The accessory clip 106 is then moved toward the baseplate assembly 104 such that the two locking tabs 144 extend through the two locking ports 124 outwardly of the two locking arms 132. As the two locking tabs 144 are moving through the two locking ports 124, the circular center portion 154 and the two expanded end portions 156 move into a mated configuration with the circular center portion 138 and the two expanded end portions 140, respectively, thereby firmly orienting the accessory clip 106 with the baseplate assembly 104.

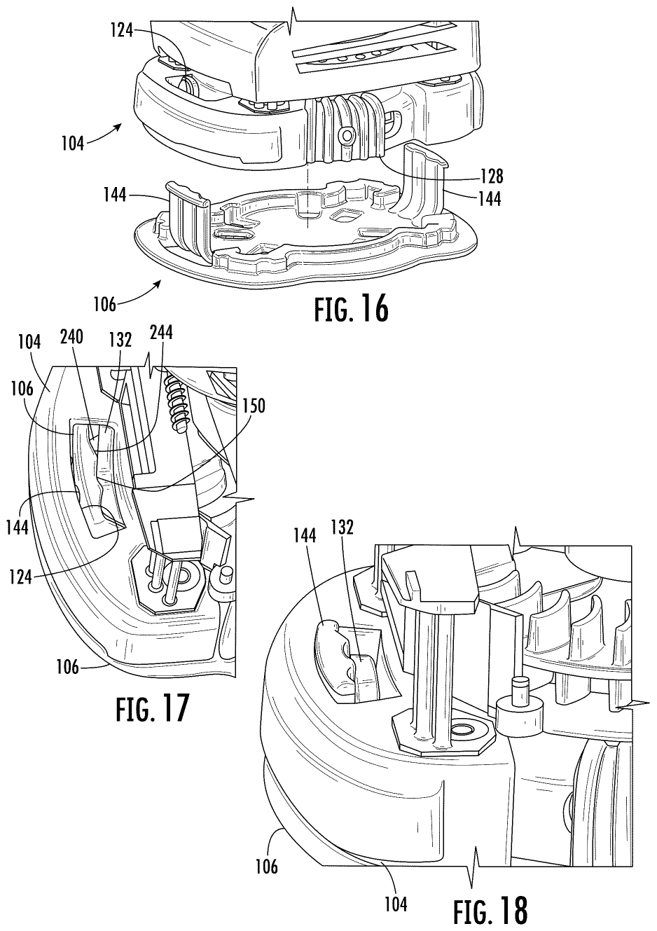

The two locking tabs 144 are sized such that moving the two locking tabs 144 through the two locking ports 124 does not flex the two locking tabs 144 inwardly resulting in the configuration of FIG. 17. In FIG. 17, the two locking tabs 144 are positioned immediately adjacent the two locking arms 132. A respective latching member 240 of the two locking arms 132 is positioned in opposition to a respective end portion 242 of the two locking tabs 144. The user then moves the two lock actuators 128 toward the lock position shown in FIG. 3.

As the two lock actuators 128 are moved, the lock plate 130 rotates thus moving the two locking arms 132 in a counter-clockwise direction (as viewed in FIG. 17) about the axis 155 (see FIG. 6). This rotation forces the respective latching member 240 against a respective sloped portion 244 of the two locking arms 132 forcing the relatively flexible two locking arms 132 outwardly such that the two locking tabs 144 extend over the portions of the baseplate assembly 104 defining the two locking ports 124. Continued movement of the two lock actuators 128 forces the respective latching member 240 into the inwardly facing latch groove 150. The inwardly facing latch groove 150 and the outwardly extending locking lip 146 are sized such that while some relaxation of the outward flexing of the two locking tabs 144 occurs, a portion of the outwardly extending locking lip 146 remain extend over the portions of the baseplate assembly 104 defining the two locking ports 124. The accessory clip 106 is thus firmly attached to the baseplate assembly 104 as shown in FIG. 18.

Removal of the accessory clip 106 from the baseplate assembly 104 is accomplished by reversal of the forging process.

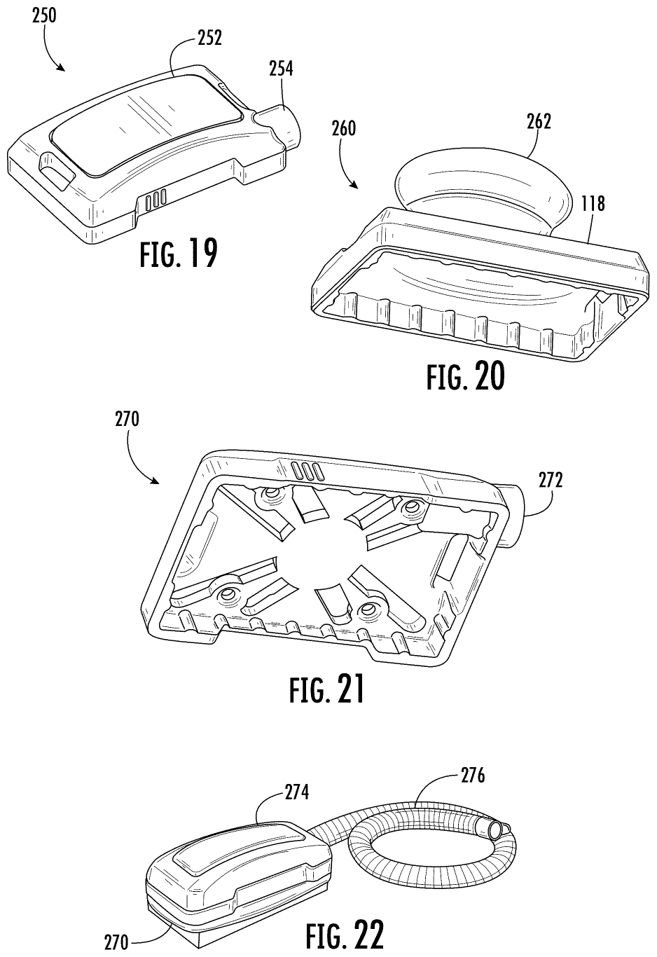

FIG. 19 shows a baseplate assembly 250 which in some embodiments is additionally or alternatively provided in the clip-accessory mounting kit. The baseplate assembly 250 is like the baseplate assembly 104 with the exception that the baseplate assembly 250 is provided as a hand-held baseplate assembly 250. Thus, the baseplate assembly 250 includes a hand grip 252 and in some embodiments a vacuum connection 254.

FIG. 20 shows a baseplate assembly 260 which in some embodiments is additionally or alternatively provided in the clip-accessory mounting kit. The baseplate assembly 260 is like the baseplate assembly 104 with the exception that the baseplate assembly 260 is provided as a hand-held baseplate assembly 260. Thus, the baseplate assembly 260 includes a hand grip 262.

FIG. 21 shows a baseplate assembly 270 which in some embodiments is additionally or alternatively provided in the clip-accessory mounting kit. The baseplate assembly 270 is like the baseplate assembly 104 with the exception that the baseplate assembly 270 includes a vacuum connection 272. This allows the baseplate assembly 270 to provide a vacuum connection for power sanders that do not include a vacuum connection as well as for a hand sander such as the hand sander 274 in FIG. 22. In some embodiments a vacuum tube 276 is separately provided in the clip-accessory mounting kit. The vacuum tube 276 can be fixedly attached to the baseplate assembly 270.

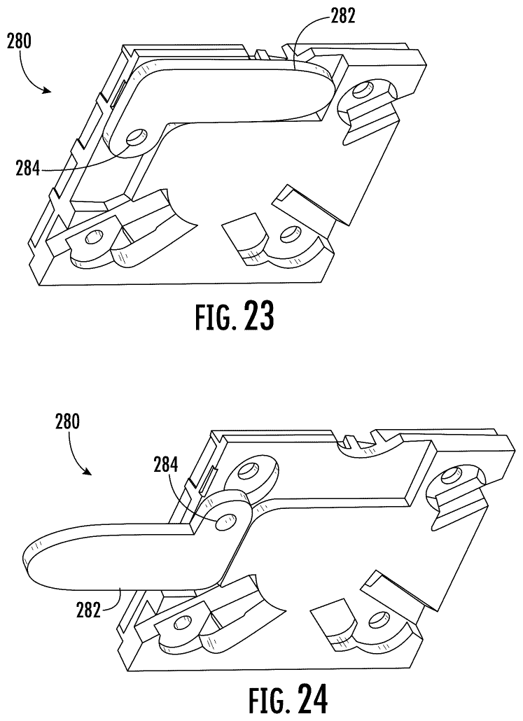

FIG. 23 shows a baseplate assembly 280 which in some embodiments is additionally or alternatively provided in the clip-accessory mounting kit. The baseplate assembly 280 is similar to the baseplate assembly 104 but includes a support member 282 which is pivotably mounted to the baseplate assembly 280 by a pivot 284 which defines a pivot axis parallel to the axis 155. By pivoting the support member 282 about the pivot 284 additional support can be provided for an accessory tool as depicted in FIG. 24.

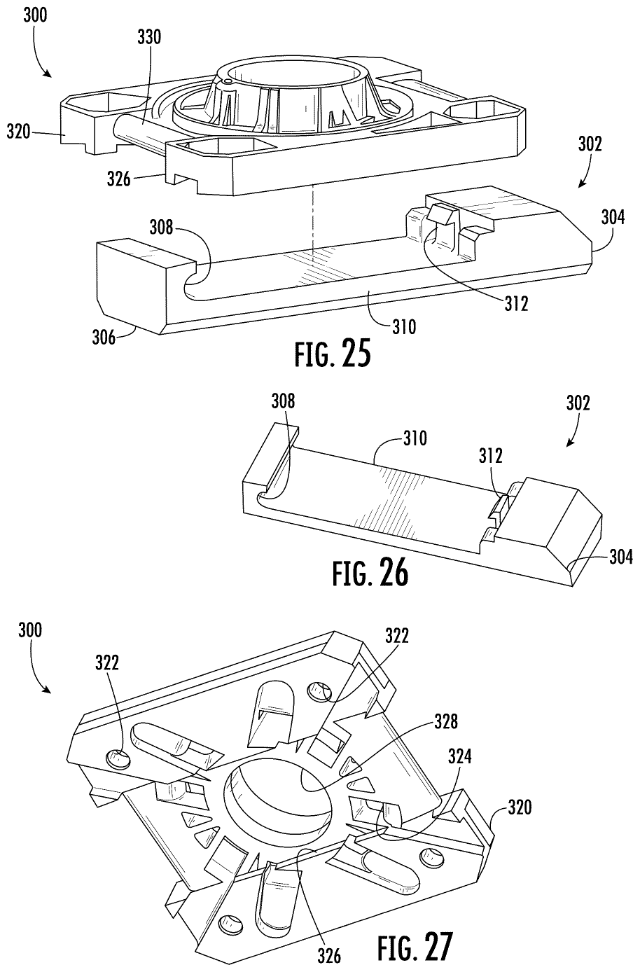

In some embodiments, the baseplate assembly 104 is additionally or alternatively configured to mate with an accessory clip which is differently configured from the accessory clip 106. For example, FIG. 25 shows a baseplate assembly 300 and an accessory clip 302. The accessory clip 302, also shown in FIG. 26, includes a body portion 304 with a lower surface 306 configured for attachment to an accessory tool. The lower surface 306 in one embodiment is provided with Velcro. A pivot member 308 extends upwardly from one end of the body portion 304. A mating portion 310 extends from the pivot member 308 to a latch portion 312.

The baseplate assembly 300, also shown in FIG. 27, includes a baseplate 320 which includes a number of through holes 322 The baseplate 320 further includes dust ports 324 and a mating channel 326. A bearing bore 328 is located in the central portion of the baseplate assembly 300. The baseplate 320 includes a pivot 330 which defines a pivot axis which is not parallel to the axis 155.

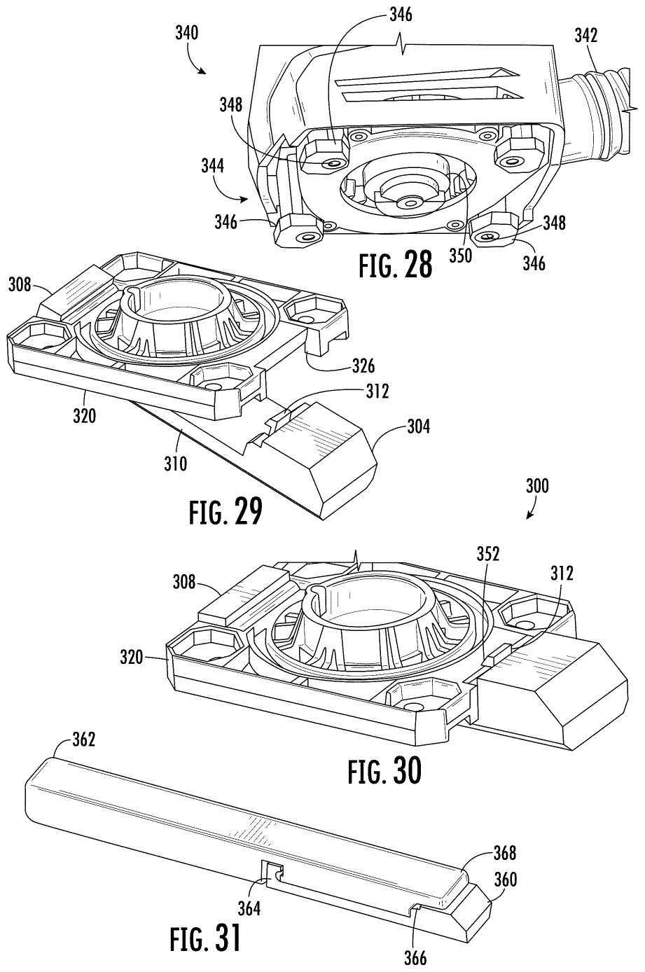

The baseplate assembly 300 is configured to attachment to a sander such as the sander 340 shown in FIG. 28. The sander 340 includes a vacuum connection 342 and an anchor subsystem 344. The anchor subsystem 344 includes a number of posts 346 which define threaded bores 348 which are used with the holes 322 to mount the baseplate assembly 300 to the sander 340 using attachment members such as the screws 120 of FIG. 3. The bearing bore 328 of the baseplate assembly 300 (see FIG. 27) is configured to receive an eccentric bearing 350 of the sander 340.

Attachment of the accessory clip 302 to the baseplate assembly 300 is accomplished by engaging the pivot 330 of the baseplate assembly 300 with the pivot member 308 of the accessory clip 302 as shown in FIG. 29. The accessory clip 302 is then rotated counterclockwise from the position shown in FIG. 29 to the position shown in FIG. 30. As the accessory clip 302 is rotated, the mating portion 310 of the accessory clip 302 is moved into the mating channel 326 of the baseplate assembly 300 thereby providing a keyed engagement. The rotation further brings a lip 352 of the latch portion 312 into engagement with the baseplate 320. The lip 352 is resiliently deformed outwardly until it is rotated above the baseplate 320 at which time it resiliently moves inwardly to latch the accessory clip 302 to the baseplate assembly 300.

While the accessory clips are shown as extending completely across the bottom of the associated baseplate assembly in the foregoing embodiments. in some embodiments the accessory clip does not extend completely across the bottom of the associated baseplate assembly. By way of example, FIG. 31 depicts an accessory clip 360 which extends only partly across the bottom of an associated baseplate assembly 362. The accessory clip 360 is attached to the associated baseplate assembly 362 using a pivoting configuration 364 like that the of the baseplate assembly 300 and accessory clip 302. A latching configuration 366 is likewise similar to the configuration of the baseplate assembly 300 and accessory clip 302. The latching configuration 366 differs, however, in that the lip of the 366 is hidden and can be configured to be flexed inwardly or outwardly as a result of an overhanging support portion 368 of the associated baseplate assembly 362.

While in some embodiments accessory tools are removably mounted to the accessory clips in the kit, in other embodiments one or more of the accessory tools is permanently fixed to an associated accessory clip. Moreover, while some features were shown in association with particular components, those features in other embodiments are provided with the other disclosed components.

The disclosed clip-accessory mounting system for a sander provides an innovative design which enhances the functionality and ease of use of sanding tools. The disclosed system provides for quick and secure attachment of various accessories to sanders, improving their versatility and efficiency. The sander is equipped with a mounting post, which serves as the primary attachment point for the baseplate. This post is strategically positioned to ensure stability and ease of access. An accessory clip, also referred to herein as an adapter, is designed to fit securely onto the baseplate.

The disclosed clip-accessory mounting system includes a lock button which ensures that the accessory clip is securely fastened to the sander. The lock button has a locked position and a released position. When the lock button is in the locked position, the accessory clip is firmly attached to the baseplate, preventing any accidental detachment during operation. In the released position, the lock button allows for easy removal of the accessory clip, facilitating quick changes between different accessories.

The disclosed clip-accessory mounting system includes a baseplate secured to the mounting post by screws. This robust attachment ensures that the baseplate remains stable during use, providing a solid foundation for the sanding process. The baseplate is designed with holes to allow for efficient dust collection. These holes help in maintaining a clean working environment by directing dust and debris away from the sanding surface and into a dust collection system.

The disclosed clip-accessory mounting system thus enhances the functionality of a sander by allowing users to quickly and easily switch between different accessories. This adaptability makes the sander suitable for a wide range of applications, from fine finishing to heavy-duty sanding tasks. The secure locking mechanism ensures that accessories remain firmly attached during use, providing a reliable and safe operation. The ability to attach various accessories makes the sander a multi-functional tool. The quick-release lock button allows for fast and effortless changes between accessories. The secure attachment of the baseplate and accessories ensures stable and precise sanding. The integrated dust collection holes help maintain a cleaner work environment, improving visibility and reducing health hazards.

In summary, the Clip-Accessory Mounting System for sanders is a well-designed innovation that significantly enhances the tool's versatility, ease of use, and overall performance. This system is ideal for both professional and DIY users who require a reliable and adaptable sanding solution.

What is claimed is:

1. A power tool system, comprising:
a hand power tool; and
a baseplate assembly configured to be mounted on the hand power tool,
wherein
the baseplate assembly includes a locking member configured to rotate about a first axis,
the locking member is configured to rotate about the first axis between a first position whereat an accessory clip cannot be locked to the baseplate assembly, and a second position whereat the accessory clip can be locked to the baseplate assembly, and
the locking member is configured to flex a portion of the accessory clip away from the first axis as the locking member rotates from the first position to the second position during a mounting process thereby locking the accessory clip to the baseplate assembly.

2. The power tool system of claim 1, further comprising:
a baseplate of the baseplate assembly, wherein the baseplate assembly is configured to be mounted to the hand power tool by attachment of the baseplate to the hand power tool, the baseplate including a locking port,
wherein
the locking member includes a locking plate and a locking arm extending upwardly from the locking plate and configured to extend into the locking port,
the locking port is configured to receive a locking tab, of the accessory clip, outwardly of the locking arm when the locking arm is extended into the locking port,
the locking tab is the portion of the accessory clip which the locking member is configured to flex, and
the locking member is configured to flex the locking tab with the locking arm.

3. The power tool system of claim 2, wherein,
the locking port is configured to receive the locking tab, including an outwardly extending locking lip of the locking tab, without flexing of the locking tab; and
the locking port is configured such that as the locking arm flexes the locking tab, the outwardly extending locking lip extends over a portion of the baseplate.

4. The power tool system of claim 3, wherein:
the locking arm includes an outwardly extending latching member configured to contact a sloped portion of the locking tab as the locking arm flexes the locking tab; and
the latching member is configured to be positioned at least partially within an inwardly facing groove of the locking tab when the locking member is in the second position with the locking tab positioned outwardly of the locking arm.

5. The power tool system of claim 4, wherein:
the locking plate includes a circular center portion configured to mate with a circular center portion of the accessory clip; and
the locking plate includes an expanded end portion configured to mate with an expanded end portion of the accessory clip,
such that when the locking tab is positioned in the locking port outwardly of the locking arm, the circular center portions of the locking plate and the accessory clip are mated and the expanded end portions of the locking plate and the accessory clip are mated thereby firmly orienting the accessory clip with the baseplate assembly.

6. The power tool system of claim 5, wherein:
the baseplate includes a first plurality of dust ports;
the locking plate includes a second plurality of dust ports; and
the first plurality of dust ports and the second plurality of dust ports are configured such that when the accessory clip is locked to the baseplate assembly, the first plurality of dust ports and the second plurality of dust ports are aligned with a third plurality of dust ports of the accessory clip.

7. The power tool system of claim 6, further comprising the accessory clip.

8. The power tool system of claim 7, wherein the accessory clip is configured to couple with a tool selected from a group of tools consisting of:
a curved detail sponge tool;
a straight scraper tool;
a sand paper sander tool;
a detailer tool;
a sanding block tool;
a scuff pad tool;
a pull scraper tool; and
a wire brush tool.

9. The power tool system of claim 8, wherein the accessory clip is configured to couple with the selected tool using Velcro.

10. The power tool system of claim 7, wherein:
the power tool system includes a scraper tool;
the accessory clip is configured to couple with the scraper tool;
the accessory clip includes a first mounting area including an anchor portion, a plurality of ribs, and a base support flange;
the scraper tool includes a base portion configured to be positioned on the base portion of the accessory clip in the first mounting area, two support wings extending upwardly from the base portion and configured to be positioned against the plurality of ribs, a mounting hole extending through the base portion and configured to align with the anchor portion, a scraper blade extending downwardly from one end of the base portion, and a support flange extending downwardly from an opposite end of the base portion and configured to abut a portion of the base support flange in the first mounting area.

11. The power tool system of claim 10, wherein;
the accessory clip includes a second mounting area including a further anchor portion, a further plurality of ribs, and the base support flange; and
the scraper tool base portion is configured to be positioned on the base portion of the accessory clip in the second mounting area, the two support wings are configured to be positioned against the further plurality of ribs, the mounting hole is configured to align with the further anchor portion, and the support flange is configured to abut a portion of the base support flange in the second mounting area.

12. The power tool system of claim 1, further comprising:
a baseplate of the baseplate assembly, wherein the baseplate assembly includes a support member pivotably mounted to the baseplate assembly by a pivot defining a pivot axis parallel to the first axis.

13. The power tool system of claim 2, the baseplate further comprising:
a pivot; and
a mating channel,
wherein
the pivot is configured to couple with a pivot member of a further accessory clip, and
the mating channel is configured to provide a keyed engagement with the further accessory clip.

14. The power tool system of claim 13, wherein:
the baseplate is further configured to form a latching configuration with the further accessory clip.
